(19) United States
(12) Patent Application Publication
(10) Pub. No.: US 2012/0144190 A1
(43) Pub. Date: Jun. 7, 2012

(54) DEVICES AND METHODS FOR ESTABLISHING AND VALIDATING A DIGITAL CERTIFICATE

(76) Inventors: Michael Braun, Munchen (DE); Andreas Köpf, Munchen (DE)

(21) Appl. No.: 13/381,708

(22) PCT Filed: May 3, 2010
(86) PCT No.: PCT/EP2010/055970

§ 371 Date: Feb. 22, 2012

(30) Foreign Application Priority Data
Jun. 30, 2009 (DE) 10 2009 031 143.2

(51) Int. Cl. G06F 21/00

(52) U.S. Cl. 713/156

(57) ABSTRACT

A digital certificate is configured to confirm the association of a public key assigned to a device as the owner of the public key to the device. The digital certificate further has an additional digital certificate, the additional digital certificate being a certificate of an additional device configured to digitally sign the digital certificate of the device. The certification process can be improved, wherein particularly the verification of digital certificates is improved. The various embodiments are particularly useful for applications where a secure communication of information or data is desired and/or should be made possible.

### CROSS-REFERENCE TO RELATED APPLICATIONS

This application is a U.S. National Stage Application of International Application No. PCT/EP2010/055970 filed May 3, 2010, which designates the United States of America, and claims priority to German Patent Application No. 10 2009 031 143.2 filed Jun. 30, 2009. The contents of which are hereby incorporated by reference in their entirety.

### TECHNICAL FIELD

The present invention relates to the establishment and the validation (or checking) of a digital certificate and the design of the digital certificate. The present invention relates in particular to a device and a method for establishing a digital certificate, a device and a method for validating the digital certificate, and the certificate constructed and to be validated according to the invention. Furthermore, the present invention relates to suitably designed computer program products and data media, through whose use the inventive establishment or validation of a digital certificate can be realized. In addition, the present invention relates to a system that has at least one of the above-mentioned devices.

### BACKGROUND

Due to the increasing use of communications networks such as the Internet or Intranet, for example, the transmitted data are available to practically every subscriber of these communications networks. However, this not always desired by the subscribers of the communications networks. The subscribers and the providers of the communications networks are interested in secure transmission of data and information. Communications channels employed in “open” communications networks such as the Internet or Intranet, for example, are, however, not secure per se. Subscribers and providers in the communications networks consequently face security problems which are defined in particular by the following general security requirements: integrity, authenticity, liability and confidentiality. Integrity means that the communications channels of the communications networks are in principle accessible to everyone. Authenticity means that the author of a message must be clearly identifiable. Liability, in turn, means that the author of a message can be made responsible for this message. In this context, confidentiality means that the data or information transmitted or communicated in the communications networks are basically accessible to everyone, it usually being possible for a message with data or information to be intended to be read only by that person to which it is addressed.

The subject matter of the various embodiments relates in particular to the confidentiality aspect or security requirement. At the same time it should be noted of course that the other security requirements are taken into account by various embodiments.

Security based on mutual trust is achieved by the use of and within so-called security infrastructures or security structures. Moreover, key management is employed to prevent anyone participating in communication under a false identity by publishing his own digital key under a false name, for example, and thus obtaining messages, data or information which are actually intended for another person whose name he is using. By the use of security infrastructures a public key of a subscriber is only valid when the key, together with its association with this subscriber has been “authenticated” or certified by a trustworthy, central authority. The authority, unit, component or device which carries out this certification is termed a certification authority (“CA” in the following). The authenticated key (authenticated with the digital signature of the corresponding CA) is then located on the certificate of the corresponding subscriber. In this case the term “subscriber” is understood to mean in particular those devices which participate in communication (for example servers, clients, printers, etc.).

At this point it should be noted that such security infrastructures or security structures with CAs are generally known. Moreover, the certification methods employed in the context of these security infrastructures or security structures, which use digital certificates and digital signatures to confirm (public) keys and data of a subscriber in the communications network as belonging to the subscriber, are also generally known. Likewise, an expert dealing with such security infrastructures or security structures is also familiar with the use of and/or the respective structure of digital certificates, digital signatures and/or (public and/or private) keys for the encryption and/or decryption of data. These concepts are therefore used below in the way that they are usually understood by an expert.

The known certification methods do of course have disadvantages when it involves the verification of certificates by a subscriber in the communications network. The security infrastructures or security structures usually have a tree-like structure, that is to say they have a tree structure or at least a hierarchical structure. If secure communication is established between two subscribers “A” and “B” in a communications network, then a confidential relationship must also be established between “A” and “B”. So, for example, a subscriber “A” must use a specific public key of a subscriber “B” in order to communicate specific data in encrypted form to subscriber “B”. For this, “A” must check the digital certificate of “B” and the digital certificates of those nodes or subscribers of the respective security infrastructure or security structure, which are superordinate to “B” in the respective security infrastructure or security structure, in order to trust the public key of the subscriber “B”.

The known methods for the verification of certificates are very time-consuming, particularly when it involves the determination or recording of all relevant certificates and their examination. Furthermore, they require a considerable administrative outlay. This is particularly the case with decentralized systems, since here, for example, no common certificate server is available and a large number of certificates has to be locally stored. At the same time, it can also happen that the establishment of a confidential relationship fails due to administrative difficulties and the excessive outlay.

### SUMMARY According to various embodiments, an improved form of procedure which improves the verification of digital certificates can be provided.

According to an embodiment, a first device can be configured for the establishment of a digital certificate, it being possible for the first device to be configured during the establishment of the digital certificate to integrate an additional digital certificate into the digital certificate, it being possible for the additional digital certificate to be a certificate of an additional device, which is designed to digitally sign the digital certificate of the first device.

According to a further embodiment, it is possible for the first device to be configured during the establishment of the digital certificate to integrate into the digital certificate: data of the first device, a public key assigned to the first device and a digital signature of the additional device, it is possible for the digital signature to confirm the data as data of the first device and the public key assigned to the first device as a public key of the first device. According to a further embodiment, it is possible for the first device to be configured to integrate the additional digital certificate into an area of the digital certificate, that is predetermined for the integration of data into the digital certificate. According to a further embodiment, it is possible for the first device to be configured to transmit the digital certificate to a device communicating with the first device.

According to another embodiment, in a method for establishing a digital certificate for a device, it is possible for the establishment of the digital certificate to include an integration of an additional digital certificate into the digital certificate, it is possible for the additional digital certificate to be a certificate of an additional device, which is designed to digitally sign the digital certificate of the device.

According to yet another embodiment, a computer program product may contain a coding which is configured to implement a method as described above.

According to yet another embodiment, a data medium may contain a computer program product as claimed above.

According to yet another embodiment, a second device can be configured to verify a digital certificate of a device communicating with the second device, it being possible for the digital certificate to contain an additional digital certificate, it being possible for the additional digital certificate to be a certificate of an additional device which is designed to digitally sign the digital certificate, and it being possible for the second device to be configured during the verification of the digital certificate to verify the additional digital certificate.

According to a further embodiment of the second device, it can be possible for the digital certificate to be transmitted by the device communicating with the second device and it can be possible for the second device to be configured to receive the digital certificate.

According to yet another embodiment, in a method for verifying a digital certificate of a device, it may be possible for the digital certificate to contain an additional digital certificate, it may be possible for the additional digital certificate to be a certificate of an additional device, which is designed to digitally sign the digital certificate, and it may be possible for the verification of the digital certificate to include a verification of the additional digital certificate.

According to yet another embodiment, a computer program product may contains a coding which is configured to implement a method as described above.

According to yet another embodiment, a data medium may contain a computer program product as described above.

According to yet another embodiment, a digital certificate may be—designed to confirm an association of a public key assigned to a device with the device as owner of the public key; and may—contain an additional digital certificate, it being possible for the additional digital certificate to be a certificate of an additional device, which is designed to digitally sign the digital certificate of the device.

According to a further embodiment of the digital certificate, it may be possible for the digital certificate to contain data of the device, the public key assigned to the device and a digital signature of the additional device, it being possible for the digital signature to confirm the data as data of the device, and the public key assigned to the device as a public key of the device.

According to yet another embodiment, a system may contain at least one of the following devices:
a first device as described above; and/or
a second device communicating with the first device as described above.

### BRIEF DESCRIPTION OF THE DRAWINGS

Embodiments are described in detail below with reference to the following attached figures, wherein:

FIG. 1 shows a security infrastructure or a security structure, which can be implemented with reference to the various embodiments;

FIG. 2 shows a certificate structure or a digital certificate, respectively, according to an exemplary embodiment;

FIG. 3 shows a security infrastructure or a security structure which is implemented with reference to an exemplary embodiment;

FIG. 4 shows a certificate structure or a digital certificate, respectively, according to an exemplary embodiment; and

FIG. 5 shows the communication and verification of a certificate according to an exemplary embodiment.

### DETAILED DESCRIPTION

According to various embodiments, a device can be configured for establishing a digital certificate. At the same time, the device is configured during the establishment of the digital certificate to integrate a further digital certificate into the digital certificate, it being possible for the additional digital certificate to be a certificate of a further device that is designed for the digital signing of the digital certificate of the device.

The digital certificate is also designed in particular to confirm an association of a public key assigned to the device, that is provided for encryption of data by the device, and that the device is owner of the public key.

A digital certificate generally refers to structured data which confirm the owner (in this case an appropriate device as owner), as well as further properties of a public key. A public key used to encrypt data can be assigned to an identity (here of a device), by means of a digital certificate. The validity of the public key is determined in this way and due to the use of digital certificates facilitates the protection of confidentiality, authenticity and integrity of data through the correct use of the public key.

The establishment of a digital certificate and the digital certificates established according to various embodiments enable a more flexible and more efficient verification of digital certificates. At the same time, it is not necessary for the verifying subscriber or the verifying device to have knowledge of those subscribers of the communications network and of the security structure, which are available to the node or subscriber of the communications network whose certificate is being checked. Various embodiments enable verification of digital certificates that is independent of the construction of the security structure. Furthermore, the administrative outlay for determining and recording digital certificates is appreciably reduced. Moreover, the various embodiments also allow a time-saving and faster verification of digital certificates. The capacity of the verifying device, that is to say the device carrying out the verification, is also increased in this way.

According to an exemplary embodiment, the device is configured during the establishment of the digital certificate to integrate into the digital certificate: data of the device, a public key assigned to the device and a digital signature of the additional device, it being possible for the digital signature to confirm the data as data of the device and the public key assigned to the device as a public key of the device.

A digital signature can generally be established within the framework of a cryptographic method. In this case a number (the digital signature) whose authorship and association with the message can be checked by anyone, is allocated to a “message” (that is to say any data or information).

According to a further exemplary embodiment, the device is configured (during the establishment of the digital certificate) to integrate the additional digital certificate into an area or part of the digital certificate, that is intended for integration of data into the digital certificate.

The structure of conventional certificates is simply and easily modified in this way. Moreover, compatibility with known procedures for certification and for verification of digital certificates is enabled in this way.

According to an exemplary embodiment, the device is configured to transmit the digital certificate to a device communicating with the device.

According to other embodiment, a method for establishing a digital certificate for a device can be provided. Furthermore, the method includes the establishment of the digital certificate for a device. Here the establishment of the digital certificate includes integration of an additional digital certificate into the certificate, it being possible for the additional digital certificate to be a certificate of an additional device that is designed to digitally sign the digital certificate of the device.

In particular, the method is designed in such a way that the steps executed by the method are those actions of the device outlined above and described in further detail below, which is configured for the establishment of digital certificates, and correspond to their modules which are used for the establishment or provision of digital certificates according to various embodiments. That is to say, the method is implemented by the device mentioned above and explained in more detail below, that is configured for the establishment of digital certificates, and that the certificate or certificates is (are) established for this device.

According to various embodiments, a computer program product may have a coding that is configured to implement and/or execute the method outlined above and explained in detail below in order to establish a digital certificate for a device. At the same time, the coding can be contained in a data medium.

According to an exemplary embodiment, the computer program product is configured to implement this method if the computer program product is executed by means of a processing unit. According to a further exemplary embodiment, this processing unit is contained in the device outlined above and explained in detail below, and is configured to establish a digital certificate.

In addition, according to further embodiments, a data medium may include the computer program product explained above.

Moreover, according to various embodiments, a device can be configured to verify a digital certificate of a device communicating with the device, it being possible for the digital certificate to include an additional digital certificate, it being possible for the additional digital certificate to be a certificate of an additional device designed for the digital signing of the digital certificate, and it being possible for the device to be configured to carry out verification of the additional digital certificate when verifying the digital certificate.

According to an exemplary embodiment, the device communicating with the device is the device outlined above and explained in detail below, which is configured for the establishment of a digital certificate.

According to an exemplary embodiment n, the digital certificate is transmitted by the device communicating with the device. Here the device (configured for verifying a digital certificate) is configured to receive the digital certificate.

According to yet further embodiments, in a method for verifying a digital certificate of a device, it being possible for the digital certificate to contain an additional digital certificate, it being possible for the additional digital certificate to be a certificate of an additional device, which is designed to digitally sign the digital certificate, and it being possible for the verification of the digital certificate to include a verification of the additional digital certificate.

In particular, the method is designed in such a way that the steps executed by the method are actions of the device outlined above and described in further detail below, which is configured for the verification of digital certificates, and correspond to their modules which are used for the verification of digital certificates, or at least support these according to various embodiments. That is to say, the method is implemented by the device mentioned above and explained in detail below, which is configured for verifying digital certificates.

According to yet further embodiments, a computer program product may include a coding, which is configured to implement and/or execute the method for verifying a digital certificate as outlined above and explained in detail below. At the same time, the coding can be contained in a data medium.

According to an exemplary embodiment, the computer program product is configured to implement this method if the computer program product is executed by means of a processing unit. According to a further exemplary embodiment this processing unit is contained in the device outlined above and explained in detail below, which device is configured for verifying a digital certificate.

In addition, according to further embodiments, a data medium may include the computer program product explained above.

According to yet further embodiments, a digital certificate may be:
designed to confirm an association of a public key assigned to a device with the device as owner of the public key; and
may contain an additional digital certificate, it being possible for the additional digital certificate to be a certificate of an additional device, which is designed to digitally sign the digital certificate of the device.

The public key assigned to the device is designed, for example, for the encryption of data by the device and/or for checking the authenticity of the device. That is to say according to an exemplary embodiment, the public key is configured to be used during the encryption of data by the device and/or during the checking of the authenticity of the device.

According to an exemplary embodiment, the digital certificate includes data of the device, the public key assigned to the device, and a digital signature of the additional device, it being possible for the digital signature to confirm the data as data of the device and the public key assigned to the device as a public key of the device.

Furthermore, according to further embodiment, a system may have at least one of the following devices:
the device for establishing digital certificates outlined above and explained in detail below; and/or
a device communicating with the device (configured for the establishment of digital certificates), it being possible for this communicating device to correspond to the device for verifying digital certificates, as outlined above and explained in detail below.

In this case a communications link that is designed to communicate data or information, exists between the two devices.

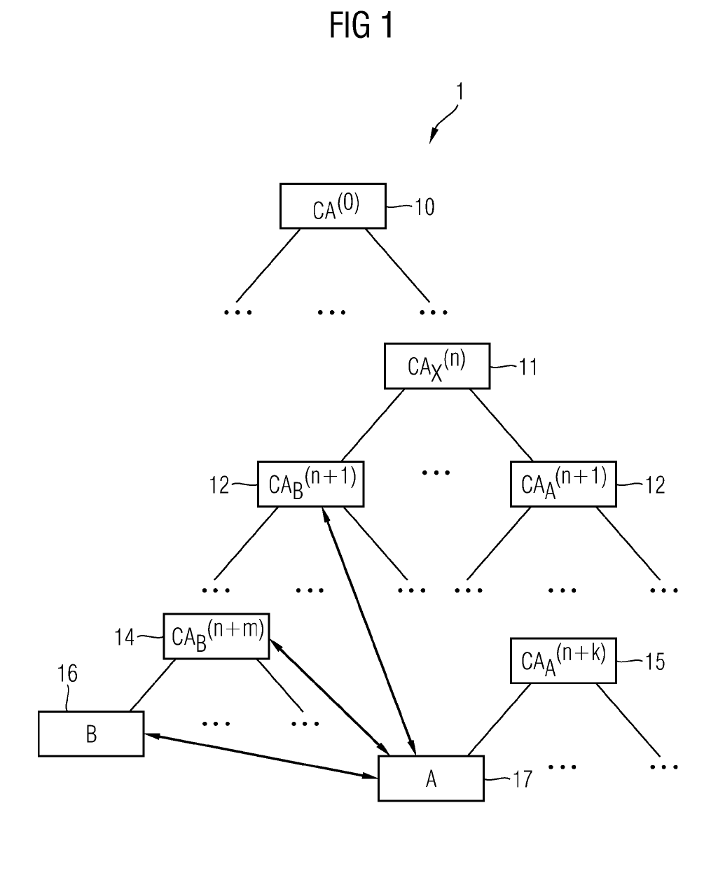

FIG. 1 shows a security infrastructure 1 or a security structure 1, which can be implemented with reference to the various embodiments.

The security structure 1 of FIG. 1 has a tree structure. Here certified subscribers can be nodes of the intermediate level or of the lowest level of the security structure 1.

According to the present exemplary embodiment, the security structure 1 is designed as a multistage CA structure. At the top of the hierarchy is located the root CA “CA^{(C)}” 10 and below this the intermediate CAs 11, 12, 13, 14, 15, which are positioned or lie in the CA structure between the root CA 10 and the leaf nodes 16, 17. An intermediate CA 11, 12, 13, 14, 15, which is located at the j^{th} step underneath the root CA 10, is denoted in FIG. 1 with a superscript “j”, that is to say as “CA^{(j)}”. According to the exemplary embodiment of FIG. 1, two entities or subscribers “A” 17 and “B” 16, which mutually establish secure communication, are seen within this CA or certificate hierarchy. In FIG. 1, the entities or subscribers “A” 17 and “B” 16 are leaf nodes of the CA structure or of the security structure 1. It should be noted, however, that the entities or subscribers “A” 17 and “B” 16 can be intermediate CAs.

According to the present exemplary embodiment, the intermediate CA “CAₓ⁽ⁿ⁾” 11 denotes the first common CA of “A” 17 and “B” 16 in the CA or certificate chain in the direction of the root CA “CA⁽⁰⁾”. It should be noted at this point that the first common CA does not necessarily have to be an intermediate CA and that a first common CA can also be the root CA 10.

According to the present exemplary embodiment, a connection is established between subscriber “A” 17 and subscriber “B 16. In order to carry out communication between “A” 17 and “B” 16, a confidentiality relationship is now established between “A” 17 and “B” 16 so that communication can be carried out in a secure manner. This definitely means that “A” 17 must trust the certificate of “B” 16 (denoted henceforth as “cert B”) and “B” 16 must trust the certificate of “A” 17. In order to clarify the description, in the following only the first case is adopted, that is to say that “A” 17 must be able to trust the certificate of “B” 16.

As a rule, the subscriber “A” 17 must possess all certificates of those intermediate CAs 14, 12, which are located in the hierarchy of the security structure 1 between the subscriber “B” 16 and the first common certification point CA “CAₓ⁽ⁿ⁾” 11 and which are superordinate to subscriber “B” 16. According to the present exemplary embodiment, these are the CAs “CA_{B}^{(+m)}” 14, “CA_{B}^{(n+m-1)}”, . . . , “CA_{B}⁽ⁿ⁺¹⁾” 12. That is to say, subscriber “A” 17 must possess the digital certificates “cert CA_{B}^{(n+m)}”, “cert CA_{B}^{(n+m-1)}”, . . . , “cert CA_{B}⁽ⁿ⁺¹⁾” to be able to verify the confidentiality relationship with subscriber “B” 16. At the same time, subscriber “A” 17 will verify all digital certificates “cert CA_{B}^{(n-m)}”, “cert CA_{B}^{(n-m-1)}”, . . . , “cert CA_{B}⁽ⁿ⁺¹⁾” or check their validity and accuracy. This is illustrated in FIG. 1 by the arrows between “A” and the respective CAs “CA_{B}^{(n+m)}” 14, “CA_{B}^{(n+m-1)}”, . . . , “CA_{B}⁽ⁿ⁺¹⁾” 12.

According to a known or normal certification procedure, subscriber “A” 17 has itself locally stored these certificates “cert CA_{B}^{(n+m)}”, “cert CA_{B}^{(n-m-1)}”, . . . , “cert CA_{B}⁽ⁿ⁺¹⁾”, or it requests them via a central certificate server, which manages all certificates of all intermediate CAs 11, 12, 13, 14, 15. If subscriber “A” 17 cannot find the appropriate certificate of an intermediate CA 11, 12, 13, 14, 15 locally, then according to the known certification procedure, subscriber “A” 17 asks for or requests the missing, non-located certificate from the certificate server. At the same time, just as with decentralized systems, such a known procedure brings with it considerable administrative outlay since in this case, for example, no common certificate server is available and a large number of certificates has to be stored locally.

According to various embodiments, a digital certificate structure is designed in such a way that the acquisition or provision of certificates of superordinate certification authorities CAs and then also the verification of these certificates can be carried out in a much more efficient manner.

In the procedure according to various embodiments, only one communications relationship needs to exist between subscriber “A” 17 and subscriber “B” 16. Subscriber “A” 17 does not have to know the chain of intermediate CAs 14, . . . , 12 from “B” 16. According to the present exemplary embodiment, a connection to a certificate server is not absolutely necessary. Moreover, no local storage of the certificate chain “cert CA_{B}^{(n+m)}”, “cert CA_{B}^{(n+m-1)}”, . . . , “cert CA_{B}⁽ⁿ⁺¹⁾” from “B” 16 by “A” 17 is necessary. According to the present exemplary embodiment, the certificate of subscriber “B” contains all information for the recursive examination of the certificate chain.

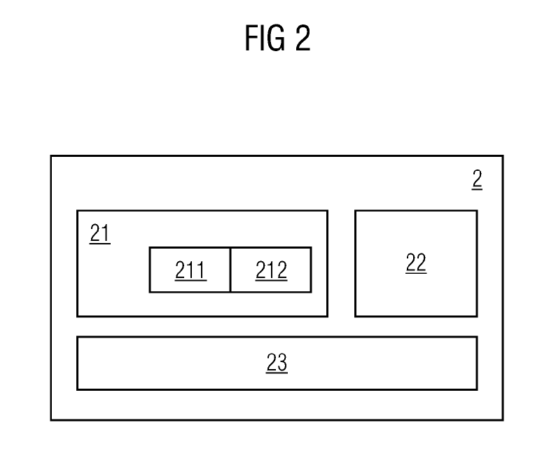

The certificate structure 2 provided in accordance with the present exemplary embodiment is shown in FIG. 2.

According to the present exemplary embodiment, the digital certificate 2 of subscriber “B” 16 has a data area or data division 21 which, in addition to the data 212, contains the certificate 211 of the superordinate intermediate CA “CA_{B}^{(n+m)}” 14. Furthermore, the digital certificate 2 of subscriber “B” 16 also includes a public key 22 of subscriber “B” 16 and a digital signature 23 relating to the data 212, the certificate 211 and the public key 22, it being possible for the digital signature 23 to be established by the superordinate intermediate CA “CA_{B}^{(n+m)}” 14.

Similarly, the certificate of the intermediate CA “CA_{B}^{(n+m)}” 14 contains the certificate of the superordinate intermediate CA “CA_{B}^{(n+m-1)}”, and so on.

That is to say, the certificate 2 is designed in such a way that it recursively contains the certificates of the respective superordinate certificate authorities CAs. The certificate of “C_{B}⁽ⁱ⁾” generally contains the certificate of the superordinate CA “C_{B}⁽ⁱ⁻¹⁾”.

Due to this recursive certificate structure, the certificate of subscriber “B” 16 contains all necessary information to allow the complete certificate chain “cert CA_{B}^{(n+m)}”, “cert CA_{B}^{(n+m-1)}”, . . . , “cert CA_{B}⁽ⁿ⁺¹⁾”, to be checked or verified. According to the present exemplary embodiment, as the content of the certificate, each entity 11, 12, 13, 14, 15, 16, 17 of the security structure 1 additionally recursively stores the CA certificates of all particular superordinate intermediate CAs 11, 12, 13, 14, 15 in the security structure 1. The magnitude of the storage requirement for the new certificate of subscriber “B” 16 actually increases by a factor n, it being possible for n to denote the depth of the certificate hierarchy from “B” to the root CA “CA⁽⁰⁾” 10; in this case, however, the efficiency and flexibility during the verification of certificates is increased by 1, it being possible for the administrative outlay to be minimized.

Here, compared to the structures of known digital certificates, the fundamental structure of the recursive certificate does not change. This has the advantage that already existing certificate software can also handle the recursive certificate structure. For example, the extension field in X.509 certificates can be used to store the certificate of the superordinate instance.

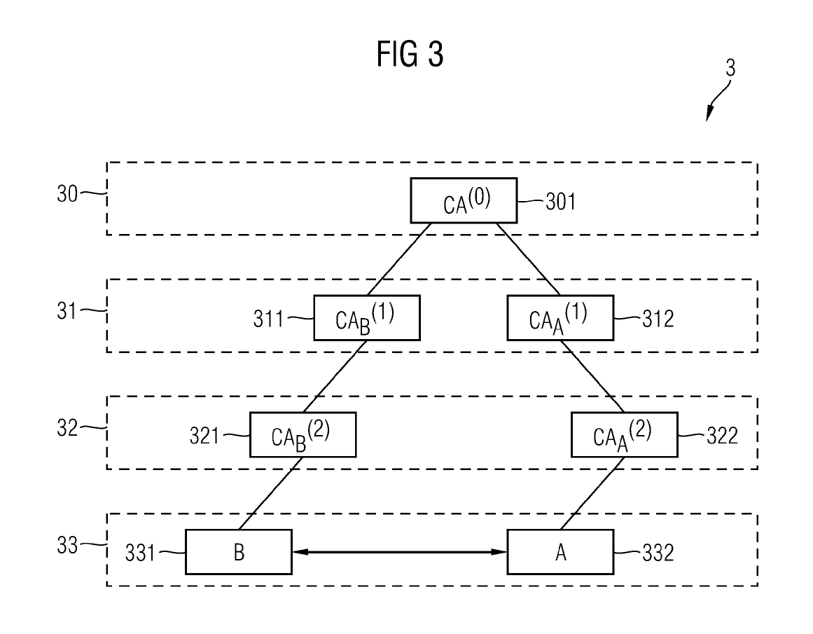

FIG. 3 shows a further security structure 3, with reference to which the various embodiments may be implemented. In particular, the verification of a digital certificate which is provided for the subscriber “B” 331 according to the present exemplary embodiment, is explained below.

The security structure 3 has a tree structure which includes four hierarchically-configured levels 30, 31, 32, 33. The uppermost level 30 contains the root CA “CA^{(C)}” 301 which, according to the present exemplary embodiment, is the first common CA between the subscribers or devices “B” 331 and “A” 332.

According to the present exemplary embodiment, level 30 is superordinate to level 31. In this case, the root CA “CA⁽⁰⁾” 301 is superordinate to the intermediate CAs “CA_{B}⁽¹⁾” 311 and “CA_{A}⁽¹⁾” 312, which are contained in level 31. Level 31 in turn is superordinate to level 32. At the same time, the intermediate CA “CA_{B}⁽¹⁾” 311 is superordinate to intermediate CA “CA_{B}⁽²⁾” 321 and the intermediate CA “CA_{A}⁽¹⁾” 312 is superordinate to the intermediate CA “CA_{A}⁽²⁾” 322, it being possible for the intermediate CAs “CA_{B}⁽²⁾” 321 and “CA_{A}⁽²⁾” 322 to be contained in level 32. The intermediate CA “CA_{B}⁽²⁾” 321 is superordinate to “B” 331 located in level 33, and the intermediate CA “CA_{A}⁽²⁾” 321 is superordinate to “A” 332 located in level 33.

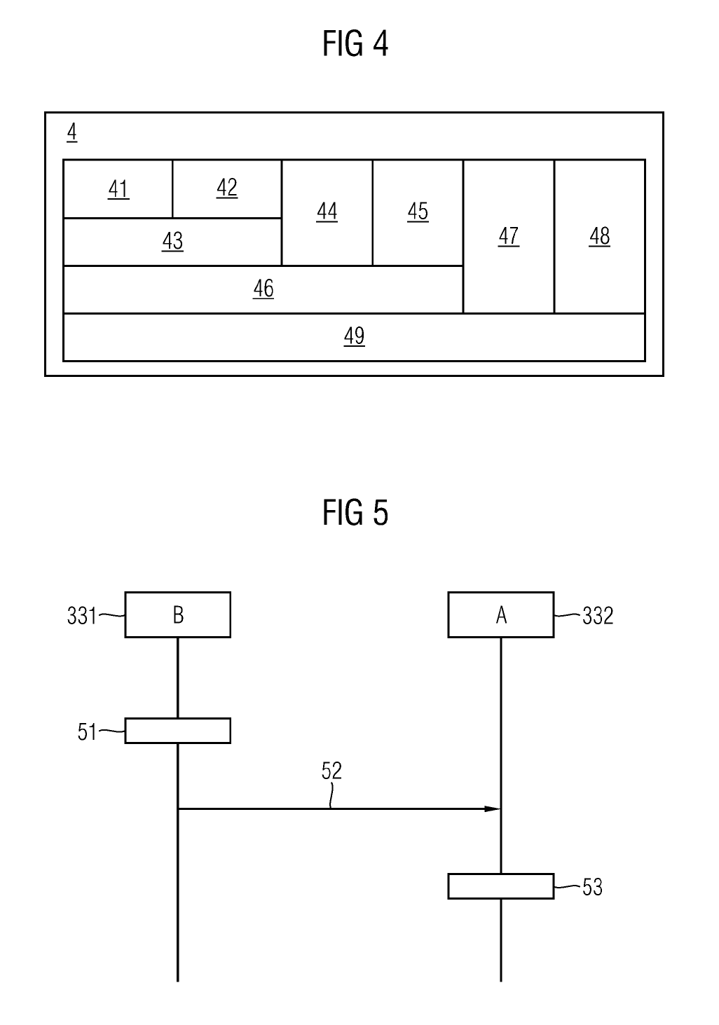

The certificate of subscriber “B” 331, which recursively contains the entire particular certificate chain up to the root CA “CA⁽⁰⁾”, is schematically constructed as shown in FIG. 4.

Here the certificate 4 of subscriber “B” 331 contains the certificate of “CA_{B}⁽²⁾” 321 which consists of the parts 41 to 46, data 47 of the subscriber “B” 331 and the public key 48 of subscriber “B” 331. This information contained in the certificate of “B” 331 is confirmed by the digital signature 49 of “CA_{B}⁽²⁾” 321 as belonging to subscriber “B” 331.

The certificate of “CA_{B}⁽²⁾” 321 which, according to the present exemplary embodiment, consists of the parts 41 to 46, in turn contains the certificate of “CA_{B}⁽¹⁾” 311, which consists of parts 41 to 43, data 44 of “CA_{B}⁽²⁾” 321 and the public key 45 of “CA_{B}⁽²⁾” 321. This information contained in the certificate of “CA_{B}⁽²⁾” 321 is confirmed by the digital signature 46 of “CA_{B}⁽¹⁾” 311 as belonging to “CA_{B}⁽²⁾” 321.

The certificate of “CA_{B}⁽¹⁾” 311, which, according to the present embodiment, consists of the parts 41 to 43, in turn contains data 41 of “CA_{B}⁽¹⁾” 311, and the public key 42 of “CA_{B}⁽¹⁾” 311. This information 41, 42 contained in the certificate of “CA_{B}⁽¹⁾” 311, is confirmed by the digital signature 43 of “CA⁽⁰⁾” 301 as belonging to “CA_{B}⁽¹⁾” 311.

According to the present exemplary embodiment, with reference to the security diagram shown in FIG. 3, the certificate 4 of subscriber “B” 331 is checked as follows.

According to the present exemplary embodiment, the certificate 4 of subscriber “B” is signed as standard by the intermediate CA “CA_{B}⁽²⁾” 321. The respective digital signature 49 is contained in the certificate 2 of subscriber “B” 331.

To check whether “CA_{B}⁽²⁾” 321 itself is correct or trustworthy, the data 44 of “CA_{B}⁽²⁾” 321 and their public key 45, signed with the digital signature 46 of “CA_{B}⁽¹⁾” 311 are sent together in the certificate 4 of “B” 331. According to the present exemplary embodiment, these data are also sent in the extension field of the certificate 4 of subscriber “B” 331, which means that the structure of the certificate 4 of “B” 331 remains as standard.

Consequently, it can be examined whether the intermediate CA “CA_{B}⁽¹⁾” 311 trusts the intermediate CA “CA_{B}⁽²⁾” 321.

To examine whether the intermediate CA “CA_{B}⁽¹⁾” 311 is correct or trustworthy, data 41 of “CA_{B}⁽¹⁾” 311 and their public key 42, signed by “CA⁽⁰⁾” 301 are also sent in the certificate of “CA_{B}⁽¹⁾” 311.

Accordingly, it can be checked whether the intermediate CA “CA⁽⁰⁾” 301 trusts the intermediate “CA_{B}⁽¹⁾” 311.

In the particular certificate chain, subscriber “A” 332 has access to the certificate of the root CA “CA⁽⁰⁾” 301, which contains the first common CA in the security structure 3. Subscriber “A” 332 is therefore able to check the signature of the first common CA “CA⁽⁰⁾” 301 without having to examine further determinations.

If CA “CA⁽⁰⁾” 301 trusts “CA_{B}⁽¹⁾” 311, the certificate chain is closed.

The end of the certificate chain is thus reached and subscriber “A” 332 can verify or check the certificate and the entire certificate chain of “B” 331.

FIG. 5 shows the communication between subscriber “A” 332 and subscriber “B” 331 in accordance with the present exemplary embodiment.

As explained above, in step 51 subscriber “B” 331 establishes the digital certificate 4. In step 52, “B” 331 sends subscriber “A” 332 a message with the certificate 4 of “B” 331. “A” 332 receives the message and reads the message and the certificate 4. In step 53 subscriber “A” 332 checks or verifies the certificate 4 of “B” 331 as described above, it also being possible for subscriber “A” 332 to implement the examination or verification of the certificates of the intermediate CAs “CA_{B}⁽²⁾” 321 and “CA_{B}⁽¹⁾” 311. Moreover, in step 53, subscriber “A” 332 also checks the certificate of the root CA “CA⁽⁰⁾” 301, which represents the first common CA in the security structure 3.

If the results of all verifications carried out in step 53 are positive, then a confidentiality relationship exists between subscriber “B” 331 and subscriber “A” 332. Confidential communication can therefore take place between “B” 331 and “A” 332.

If, however, at least one result of the verifications carried out in step 53 is negative, then no confidentiality relationship exists between subscriber “B” 331 and subscriber “A” 332. In this case no secure communication can take place between subscriber “B” 331 and subscriber “A” 332. Communication can then be aborted or ended.

The various embodiments therefore relate to the establishment and validation of a digital certificate. In the course of this, the digital certificate is designed to confirm an association of a public key assigned to one device with the device as owner of the public key, said public key being designed for example for the encryption of data by the device and/or for checking the authenticity of the device. Furthermore, the digital certificate contains an additional digital certificate, it being possible for the additional digital certificate to be the digital certificate of an additional device, which is designed to digitally sign the digital certificate of the device. The various embodiments facilitate an improved procedure, it being possible, in particular, to improve the verification of digital certificates. The various embodiments are particularly useful for applications where secure communication of information or data is desired and/or should be made possible.

Although the invention is explained above with reference to the exemplary embodiments and in accordance with the attached drawings, it is obvious that the invention is not restricted to these, rather it can be modified within the scope of the inventive idea disclosed above and in the attached claims. It goes without saying that still further exemplary embodiments can be produced, which illustrate the principle of the invention and are equivalent, and that various modifications can be implemented without deviating from the scope of the invention.

What is claimed is:

1. A device that is configured for the establishment of a digital certificate, wherein the device can be configured during the establishment of the digital certificate to integrate an additional digital certificate into the digital certificate, and wherein the additional digital certificate can be a certificate of an additional device which is designed to digitally sign the digital certificate of the device.

2. The device according to claim 1, wherein the device can be configured during the establishment of the digital certificate to integrate into the digital certificate: data of the device, a public key assigned to the device and a digital signature of the additional device, and wherein the digital signature can confirm the data as data of the device and the public key assigned to the device as a public key of the device.

3. The device according to claim 1, wherein the device can be configured to integrate the additional digital certificate into an area of the digital certificate, that is predetermined for the integration of data into the digital certificate.

4. The device according to claim 1, wherein the device can be configured to transmit the digital certificate to a device communicating with the devise.

5. A method for establishing a digital certificate for a device, comprising
for the establishment of the digital certificate, including an integration of an additional digital certificate into the digital certificate, wherein the additional digital certificate is a certificate of an additional device, which is designed to digitally sign the digital certificate of the device.

6. A computer program product comprising a computer readable medium containing a coding which when executed on a computer performs the step of including an integration of an additional digital certificate into a digital certificate, wherein the additional digital certificate is a certificate of an additional device, which is designed to digitally sign the digital certificate of the device.

7. (canceled)

8. A device which is configured to verify a digital certificate of a device communicating with the device, wherein the digital certificate can contain an additional digital certificate, wherein the additional digital certificate can be a certificate of an additional device which is designed to digitally sign the digital certificate, and wherein the device can be configured during the verification of the digital certificate to verify the additional digital certificate.

9. The device according to claim 8, wherein the digital certificate can be transmitted by the device communicating with the device and wherein the device can be configured to receive the digital certificate.

10. A method for verifying a digital certificate of a device, comprising:
providing for the digital certificate to contain an additional digital certificate, wherein the additional digital certificate is a certificate of an additional device, which is designed to digitally sign the digital certificate, and wherein the verification of the digital certificate includes a verification of the additional digital certificate.

11. A computer program product comprising a computer readable medium which contains a coding which when executed on a computer performs the step of providing for the digital certificate to contain an additional digital certificate, wherein the additional digital certificate is a certificate of an additional device, which is designed to digitally sign the digital certificate, and wherein the verification of the digital certificate includes a verification of the additional digital certificate.

12. (canceled)

13. A digital certificate which:
is designed to confirm an association of a public key assigned to a device with the device as owner of the public key; and
contains an additional digital certificate, wherein the additional digital certificate is a certificate of an additional device, which is designed to digitally sign the digital certificate of the device.

14. The digital certificate according to claim 13, wherein the digital certificate contains data of the device, the public key assigned to the device and a digital signature of the additional device, wherein the digital signature confirms the data as data of the device, and the public key assigned to the device as a public key of the device.

15. A system, comprising at least one of the following devices:
a first device configured for the establishment of a digital certificate, wherein the first device can be configured during the establishment of the digital certificate to integrate an additional digital certificate into the digital certificate, and wherein the additional digital certificate can be a certificate of an additional device, which is designed to digitally sign the digital certificate of the device; and
a second device communicating with the first device which is configured to verify a digital certificate of the first device communicating with the second device, wherein the digital certificate can contain an additional digital certificate, wherein the additional digital certificate can be a certificate of an additional device which is designed to digitally sign the digital certificate, and wherein the device second can be configured during the verification of the digital certificate to verify the additional digital certificate.

16. The system according to claim 15, wherein the first device can be configured during the establishment of the digital certificate to integrate into the digital certificate: data of the first device, a public key assigned to the first device and a digital signature of the additional device, and wherein the digital signature can confirm the data as data of the first device and the public key assigned to the first device as a public key of the first device.

17. The system according to claim 15, wherein the first device can be configured to integrate the additional digital certificate into an area of the digital certificate, that is predetermined for the integration of data into the digital certificate.

18. The system according to claim 15, wherein the first device can be configured to transmit the digital certificate to the second device communicating with the first device.

19. The system according to claim. 15, wherein the digital certificate can be transmitted by the second device communicating with the first device and wherein the second device can be configured to receive the digital certificate.
